(19) United States
(12) Patent Application Publication
(10) Pub. No.: US 2002/0153202 A1
(43) Pub. Date: Oct. 24, 2002

(54) Ladder step safety guard

(76) Inventors: Jay Sawicki, Westminster, CO (US); Mary Jo Sawicki, Westminster, CO (US)

Correspondence Address: Edwin H. Crabtree, Suite 575, 3773 Cherry Creek N. Drive, Denver, CO, 80209, US

(21) Appl. No.: 09/839,519

(22) Filed: Apr. 23, 2001

(51) Int. Cl. E06C 5/32

(52) U.S. Cl. 182/129

(57) ABSTRACT

A ladder step safety guard used with a step ladder and other types of ladders. The safety guard is designed to prevent a user of the ladder from stepping on a top step and the top of the ladder when in use and therefore help reduce the chance of a fall and serious injury to the user. The safety guard includes a front cover with ladder leg attachments for removably securing the front cover to the front of the top step and covering the space between the top step and the ladder top. Also, the safety guard can include a top cover for receipt over the ladder top and a rear cover for covering a space between a top back leg brace and the ladder top. Further, the guard can include tool storage pockets in the front and read covers for storing tools therein. The safety guard can be made of a flexible fabric material and similar materials having sufficient strength to guard the space between the top step and the top of the ladder.

### BACKGROUND OF THE INVENTION

(a) Field of the Invention

This invention relates to safety devices used with ladders and more particularly, but not by way of limitation, to a ladder step safety guard used to help prevent a user of a step ladder from stepping on a top step and on the top of a ladder when in use.

(b) Discussion of Prior Art

Heretofore, there have been a variety of safety devices and accessories for attaching to different types of ladders. Also, there are various types of tool carriers that are used for mounting on the top and sides of ladders for holding tools and supplies. None of these prior art safety devices and tool carriers are designed to help prevent a user of a ladder from stepping on a top step and a ladder top of a ladder.

The subject invention provides a unique safety feature, structure and function, which heretofore was not available for users of various types of ladders used at home and at work.

### SUMMARY OF THE INVENTION

In view of the foregoing, it is a primary objective of the subject invention to provide a ladder step safety guard for protecting the user of the ladder from a possible fall and serious injury. The step safety guard is designed to deter the user of the safety guard from stepping on the top step and the ladder top when using the ladder.

Yet another object of the invention is the step safety guard can be quickly attached to the top of the ladder and removed when the ladder is no longer in use. The guard is adapted for use on step ladders, ladders with rungs and various other types of ladders.

Still another object of the step guard is it can be made inexpensively of various types of materials such as a heavy flexible fabric, molded plastic, thin sheet metal and similar light weight materials.

A further object of the invention is the step guard can be constructed with tool storage pockets for providing quick access to tools and supplies when using the ladder for various maintenance and construction tasks. The step safety guard can be used with a ladder at home or on the job in commercial and industrial applications.

The ladder step safety guard includes a front cover with ladder leg attachments for removably securing the front cover next to the front of the top step and covering a space between the top step and the ladder top. Also, the safety guard can include a top cover for receipt over the ladder top and a rear cover for covering a space between a top rear leg brace and the ladder top. Further, the guard can include tool storage pockets in the front and rear covers for storing tools and supplies therein. The safety guard can be made of a flexible fabric material and similar materials having sufficient strength to guard the space between the top step and the top of the ladder and hopefully prevent a user of the ladder from stepping on the top step and the ladder top during the use of the ladder.

These and other objects of the present invention will become apparent to those familiar with safety devices related to different types of ladders when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### BRIEF DESCRIPTION OF THE DRAWINGS

The accompanying drawings illustrate complete preferred embodiments in the present invention according to the best modes presently devised for the practical application of the principles thereof, and in which:

FIG. 1 is a perspective view of the ladder step safety guard having a front cover, a top cover, a rear cover and leg attachments for removably attaching the step safety guard to the top of a ladder. A lower portion of the front cover is shown with an opening centered thereon. The opening is used to expose a typical manufactures warning on the top step of the ladder. The warning advises a user of the ladder not to step on the top step.

FIG. 2 is another perspective view of the ladder step safety guard. In this drawing, the guard is shown attached to the top of a step ladder. The ladder is shown with front legs, rear legs, a bottom step, three middle steps, a top step and a ladder top. The front cover of the ladder step guard is shown protecting and covering the space between the top of the top step and the ladder top.

FIG. 3 is a perspective view of another embodiment of the ladder step safety guard having a single front cover having loop fasteners disposed along the sides of a width and a height of the front cover and hook fasteners which are used for attachment to the front sides of the top step, the ladder top and a portion of the front ladder legs.

FIG. 4 is another perspective view of the ladder step safety guard shown in FIG. 3. In this drawing, the safety guard is shown attached to the hook fasteners. The hook fasteners are attached to an upper portion of the front of the step ladder.

### DESCRIPTION OF THE PREFERRED EMBODIMENTS

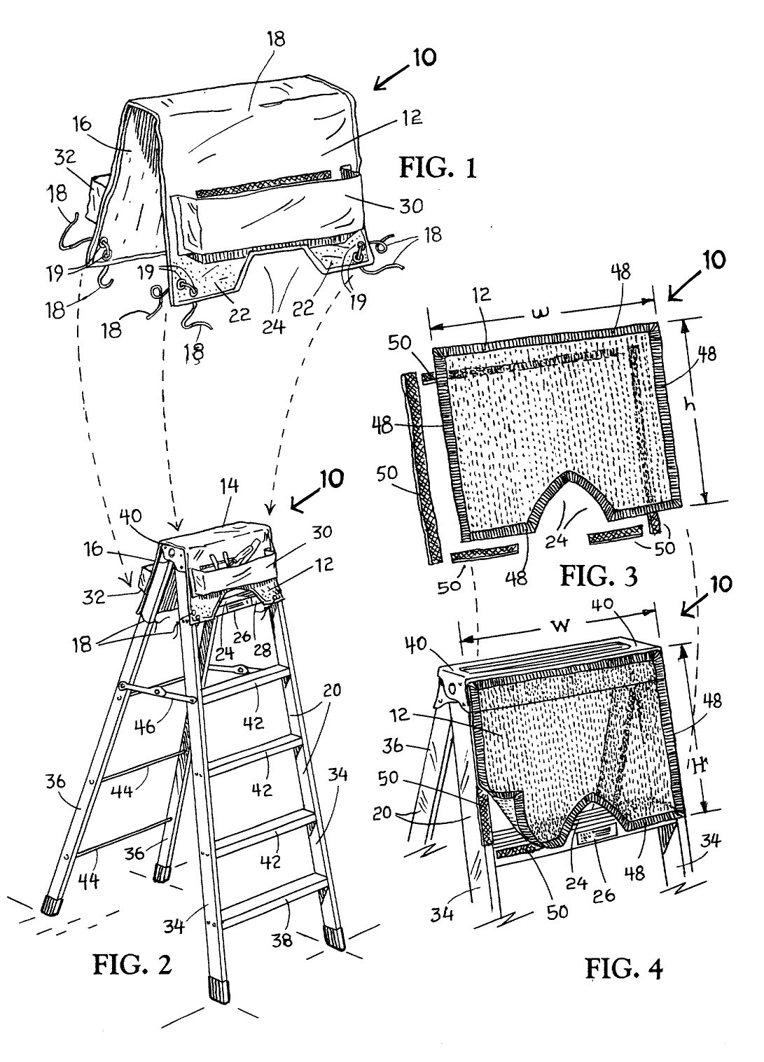

In FIG. 1, a perspective view of the ladder step safety guard is shown having a general reference numeral 10. In this embodiment, the step safety guard 10 broadly includes a front cover 12, a top cover 14, a rear cover 16 and cord leg attachments 18 for removably attaching the step safety guard 10 to the top of a step ladder 20. The cord leg attachments 18 are received through a pair of grommets 19 in the lower corners of the front and rear covers 12 and 16. The step ladder 20 is shown in FIGS. 2 and 4. While the step ladder is shown in the drawings, it can be appreciated that the subject step safety guard can be used equally well with various types of ladders.

A lower portion 22 of the front cover 12 is shown with an opening 24 centered thereon. The opening 24 is used to expose a typical manufactures “Warning” on a top step 28 of the ladder 20. The “Warning” advises a ladder user not to use the top step of the ladder. The safety guard 10 can also have a front tool storage pocket 30 attached to the front cover 12 and a rear tool storage pocket 32 attached to the rear cover 16. Obviously, the front and rear storage pockets 30 and 32 can be used for holding tools and supplies when using the safety guard 10.

In FIG. 2, another perspective view of the ladder step safety guard 10 is shown attached to the top of a step ladder 20 using the cord leg attachments 18 received around a portion of a pair of front legs 34 and a pair of rear legs 36 of the ladder 20. The ladder 20 also includes a lower step 38, a ladder top 40, three middle steps 42, rear leg braces 44 and spreader braces 46. The spreader braces 46 attached to the front and rear legs 34 and 36 for holding the ladder 20 in an open and operable position as shown.

In this drawing, the front cover 12 is shown protecting and covering the space between the top of the top step 28 and the ladder top 40. The space between the adjacent steps of the ladder 20 and the space between the pair of front legs 34 is in a range of 70 to 90 square inches. For example, a typical width between the legs is in a range of 11 to 13 inches and a typical height between the steps is in a range of 6 to 7 inches. (Jay and Mary Jo, does this sound correct???)

In FIG. 3, a perspective view of another embodiment of the ladder step safety guard 10 is shown. In this drawing, the guard 10 includes a single front cover 12 having strips of loop fasteners 48 disposed along opposite sides of the width and height of the front cover 12. The front cover 12 is illustrated having a width “w” and a height “h”. The guard 10 also includes a plurality of strips of hook fasteners 50. The hook fasteners 50 are attached to the front side of the top step 28, the front side of the ladder top 40 and the front sides of a top portion of the front ladder legs 34 between the top step 28 and the ladder top 40.

In FIG. 4, another perspective view of the ladder step safety guard 10 is shown as seen in FIG. 3. In this drawing, the loop fasteners 48, attached to the sides of the front cover 12, are releasably secured to the hook fasteners 50 attached to the front of the top step 28, the front of the ladder top 40 and the front of the top portion of the front ladder legs 34. The lower portion of the front portion 12 of the guard 10 in this embodiment also has an opening 24 centered thereon. The opening 24, as mentioned above, allowing the “Warning” 26 from the ladder manufacture to be exposed as shown.

In this drawing, the ladder top 40 is shown having a width “W” which corresponds to the width “w” of the front cover 12 shown in FIG. 3. Also, a distance from the bottom of the top step 28 and the top of the ladder top 40 has a height of “H”. Typically the width “w” and the width “W” are in a range of 11 to 13 inches. Also, the height “h” and the height “H” is typically in a range of 6 to 7 inches. Obviously, the width and height of the front cover 12 must be sufficient to allow the loop fasteners 48 to engage the hook fasteners 50 attached to the top of the ladder 20 and thereby cover the space between the top of the top step 28 and the ladder top 40.

Although the hook fasteners 50 and the loop fasteners 48 are shown in FIGS. 3 and 4 for securing the front cover 12 in front of the space between the top step 28 and the ladder top 40, it can be appreciated that various types of fasteners can be used equally well with the front cover 12 for securing it to the top of the ladder 20.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed except as precluded by the prior art.

The embodiments of the invention for which as exclusive privilege and property right is claimed are defined as follows:

1. A ladder step safety guard used with a step ladder and other types of ladders, the safety guard designed to prevent a ladder user from stepping on a top step and the top of a ladder top, the safety guard comprising:
a front cover, said front cover dimensioned to cover a space between the top step and the ladder top of the ladder; and
means for releasably attaching said front cover to the ladder and next to the top step and the ladder top.

2. The safety guard as described in claim 1 wherein said attachment means is hook and loop fasteners attached to the front cover and attached to the top step and the ladder top.

3. The safety guard as described in claim 1 wherein said attachment means is a plurality of cord leg attachments attached to said front cover for securing the front cover next to the top step and the ladder top.

4. The safety guard as described in claim 1 further including a top cover attached to said front cover and adapted for receipt over the ladder top and a rear cover attached to said top cover and adapted for receipt in front of a portion of the rear of the ladder.

5. The safety guard as described in claim 4 wherein said attachment means is a plurality of cord leg attachments attached to lower corners of said front cover and said rear cover, said cord leg attachments adapted for receipt around a portion of front and rear ladder legs.

6. The safety guard as described in claim 4 further including a front tool storage pocket attached to said front cover for holding tools and supplies therein.

7. The safety guard as described in claim 4 further including a rear tool storage pocket attached to said rear cover for holding tools and supplies therein.

8. A ladder step safety guard used with a step ladder and other types of ladders, the safety guard designed to prevent a ladder user from stepping on a top step and the top of a ladder top, the safety guard comprising:
a front cover, said front cover dimensioned to cover a space between the top step and the ladder top of the ladder, said front cover having an opening in a bottom portion thereof, said opening adapted for receipt in front of a manufactures “Warning” in a front of the top step of the ladder; and
loop fasteners attached to sides of said front covered;
hook fasteners adapted for attachment to a top portion of the ladder, said loop fasteners releasably attached to said loop fasteners.

9. The safety guard as described in claim 8 wherein said front cover has a width “w” in a range of 11 to 13 inches and a height “h” in a range of 6 to 7 inches.

10. The safety guard as described in claim 8 wherein said hook fasteners include a plurality of hook fastener strips disposed along a front side of the top step and along a front side of the ladder top.

11. The safety guard as described in claim 10 wherein said loop fasteners include a plurality of loop fastener strips disposed along opposite sides of said front cover.

12. A ladder step safety guard used with a step ladder and other types of ladders, the safety guard designed to prevent a ladder user from stepping on a top step and the top of a ladder top, the safety guard comprising:
a front cover, said front cover dimensioned to cover a space between the top step and the ladder top of the ladder;
a top cover attached to said front cover and adapted for receipt over the ladder top; and
a rear cover attached to said top cover and adapted for receipt in front of a portion of the rear of the ladder.

13. The safety guard as described in claim 12 further including attachment means for releasably securing said front cover and said rear cover to the ladder.

14. The safety guard as described in claim 13 wherein said attachment means is a plurality of cord leg attachments attached to lower corners of said front cover and said rear cover, said cord leg attachments adapted for receipt around a portion of front and rear ladder legs of the ladder.

15. The safety guard as described in claim 12 further including a front tool storage pocket attached to said front cover for holding tools and supplies therein.

16. The safety guard as described in claim 12 further including a rear tool storage pocket attached to said rear cover for holding tools and supplies therein.

17. The safety guard as described in claim 12 wherein said front cover is dimensioned to cover a space between the top step and the ladder top of the ladder, said front cover having an opening in a bottom portion thereof, said opening adapted for receipt in front of a manufactures “Warning” in a front of the top step of the ladder.
